(19) United States
(12) Patent Application Publication
(10) Pub. No.: US 2026/0241633 A1
(43) Pub. Date: Aug. 20, 2026

(54) PRODUCTION METHOD FOR SHAPED FIBER SHEET, SHAPED FIBER SHEET, AND FIBER PRODUCT

(71) Applicant: CHORI CO., LTD., Osaka (JP)

(72) Inventors: Takahiro YAMAGUCHI, Osaka (JP); Hirofumi ARIKAWA, Osaka (JP)

(73) Assignee: CHORI CO., LTD., Osaka (JP)

(21) Appl. No.: 19/161,524

(22) PCT Filed: Feb. 27, 2024
(86) PCT No.: PCT/JP2024/007110

§ 371 Date: Sep. 2, 2025

(30) Foreign Application Priority Data
Mar. 6, 2023 (JP) 2023-033585

(51) Int. Cl. B29C 53/26; B29C 53/28; B29C 53/84; B29K 105/08; B29L 7/00; B29L 9/00

(52) U.S. Cl. CPC B29C 53/265; B29C 53/28; B29C 53/84; B29K 2105/0854; B29L 2007/001; B29L 2009/00

(57) ABSTRACT

The present invention comprises: a step for bending a long fiber sheet (20) so that the fiber sheet (20) is wrinkled in the width direction so as to include lengthwise protruding sections (20a), while the fiber sheet (20) is being conveyed; a step for conveying the fiber sheet (20), which has been bent so as to be wrinkled in the width direction, between a pair of continuous tracks (13a, 16a) that drive in the conveyance direction, and thus partially pressing the lengthwise protruding sections (20a) by interlocking of shaped members (14, 17) that are provided in rows along the conveyance direction on each of the pair of continuous tracks (13a, 16a); and a step for heating the fiber sheet (20) that has been bent so that protruded/depressed shapes are exhibited by partially pressing the lengthwise protruding sections (20a).

### TECHNICAL FIELD

The present invention relates to a production method for a shaped fiber sheet, a shaped fiber sheet, and a fiber product.

### BACKGROUND ART

There has been known a shaped fiber sheet obtained by forming uneven shapes on a fiber sheet and a method for producing the shaped fiber sheet. For example, a known method for producing a shaped fiber sheet includes processing a flat long fiber nonwoven fabric (a fiber sheet), while substantially maintaining the thickness of the nonwoven fabric, so that the nonwoven fabric becomes three-dimensionally high in the thickness direction to obtain a long fiber nonwoven fabric (a shaped fiber sheet) on which creases forming an irregular uneven shape and having an extreme difference in height are formed. (See Patent Document 1).

In the production method of Patent Document 1, a yet-to-be creased long fiber nonwoven fabric is packed in a bag and wet heat (hot water, steam, or the like of 60° C. or higher) is applied to the long fiber nonwoven fabric so as to have creases thereon.

### CITATION LIST

Patent Document: Japanese Patent No. 5752775

### DISCLOSURE OF THE INVENTION

### Problems to be Solved by the Invention

However, in the shaped fiber sheet produced by the production method of Patent Document 1, the creases form an irregular uneven shape, and therefore, the shape, the number, and the height of uneven shapes are formed by the course of nature. This gives rise to a problem in that the shaped fiber sheet is inconvenient to use: specifically, the external shape of the shaped fiber is not prescribable, it is hard to spread the shaped fiber sheet, a straight line of the outer periphery of the shaped fiber sheet is lost, cutting the shaped fiber sheet involves a large loss, workability at the time of sewing the shaped fiber sheet is not good, and the like. There is a problem in that the production method of Patent Document 1 is unsuitable for continuous production and production efficiency is low.

An object of the present invention is to provide a method for producing a shaped fiber sheet with high production efficiency, and a shaped fiber sheet and a fiber product that are convenient to use.

### Problems to be Solved by the Invention

A method for producing a shaped fiber sheet according to the present invention includes: a bending step including bending a long fiber sheet while conveying the fiber sheet so that the fiber sheet is creased in a width direction to include a longitudinal crest portion and/or a longitudinal trough portion extending in a longitudinal direction along a conveyance direction; a partially pressing step including conveying the fiber sheet bent and creased in the width direction to between endless tracks that are provided on both sides of the fiber sheet in a thickness direction and driven in the conveyance direction and that have shaping members disposed in a row in the conveyance direction, and partially pressing the longitudinal crest portion and/or the longitudinal trough portion with meshing of the shaping members; and a heating step including heating the fiber sheet that has been bent and assumes an uneven shape as a result of partially pressing the longitudinal crest portion and/or the longitudinal trough portion.

A shaped fiber sheet according to the present invention includes a region where a plurality of uneven shapes having regularity are formed, a coefficient of extension in the region is 20% or higher, and a ratio of a projection area of the shaped fiber sheet to a surface area of the fiber sheet before the uneven shapes are formed is 80% or lower.

A fiber product according to the present invention includes the shaped fiber sheet produced by the method for producing the shaped fiber sheet according to the present invention as padding.

### Effects of the Invention

With the production method for the shaped fiber sheet, the shaped fiber sheet, and the fiber product of the present invention, it is possible to provide a production method for a shaped fiber sheet with high production efficiency and a shaped fiber sheet and a fiber product convenient to use.

### BRIEF DESCRIPTION OF THE DRAWINGS

FIG. 1 is an explanatory diagram illustrating an example of a production apparatus for a shaped fiber sheet according to an embodiment of the present invention.

FIG. 2 is an explanatory diagram illustrating an example of a configuration of the production apparatus for the shaped fiber sheet according to the embodiment of the present invention.

FIG. 3 is an explanatory diagram illustrating an example of a step of bending, in a width direction, a fiber sheet according to the embodiment of the present invention.

FIG. 4 is an explanatory diagram illustrating the example of the step of bending, in the width direction, the fiber sheet according to the embodiment of the present invention.

FIG. 5 is an explanatory diagram illustrating the example of the step of bending, in the width direction, the fiber sheet according to the embodiment of the present invention.

FIG. 6 is an explanatory diagram illustrating the example of the step of bending, in the width direction, the fiber sheet according to the embodiment of the present invention.

FIG. 7 is an explanatory diagram illustrating an example at the time of shaping uneven shapes on the fiber sheet according to the embodiment of the present invention.

FIG. 8 is an explanatory diagram illustrating the example at the time of shaping the uneven shapes on the fiber sheet according to the embodiment of the present invention.

FIG. 9 is an explanatory diagram illustrating the example at the time of shaping the uneven shapes on the fiber sheet according to the embodiment of the present invention.

FIG. 10 is a front perspective view illustrating an example of a shaped fiber sheet according to the embodiment of the present invention.

FIG. 11 is an explanatory diagram illustrating an example of a production method for a shaped fiber sheet according to a modification of the embodiment of the present invention.

FIG. 12 is an explanatory diagram illustrating an example of a production method for a shaped fiber sheet according to the modification of the embodiment of the present invention.

FIG. 13 is an explanatory diagram illustrating the example of a production method for a shaped fiber sheet according to the modification of the embodiment of the present invention.

FIG. 14 is an explanatory diagram illustrating an example of a production method for a shaped fiber sheet according to the modification of the embodiment of the present invention.

FIG. 15 is an explanatory diagram illustrating the example of a production method for a shaped fiber sheet according to the modification of the embodiment of the present invention.

FIG. 16 is an explanatory diagram illustrating an example of shaping members according to the modification of the embodiment of the present invention.

FIG. 17 is an explanatory diagram illustrating an example of shaping members according to the modification of the embodiment of the present invention.

FIG. 18 is an explanatory diagram illustrating an example of shaping members according to the modification of the embodiment of the present invention.

FIG. 19 is an explanatory diagram illustrating an example of shaping members according to the modification of the embodiment of the present invention.

FIG. 20 is an explanatory diagram illustrating an example of shaping members according to the modification of the embodiment of the present invention.

FIG. 21 is an explanatory diagram illustrating an example of comparing gaps in the case in which the shaped fiber sheet according to the embodiment of the present invention is used as padding of a quilt and the case in which a heat insulating material of the related art is used as the padding of the quilt.

### PREFERRED MODE FOR CARRYING OUT THE INVENTION

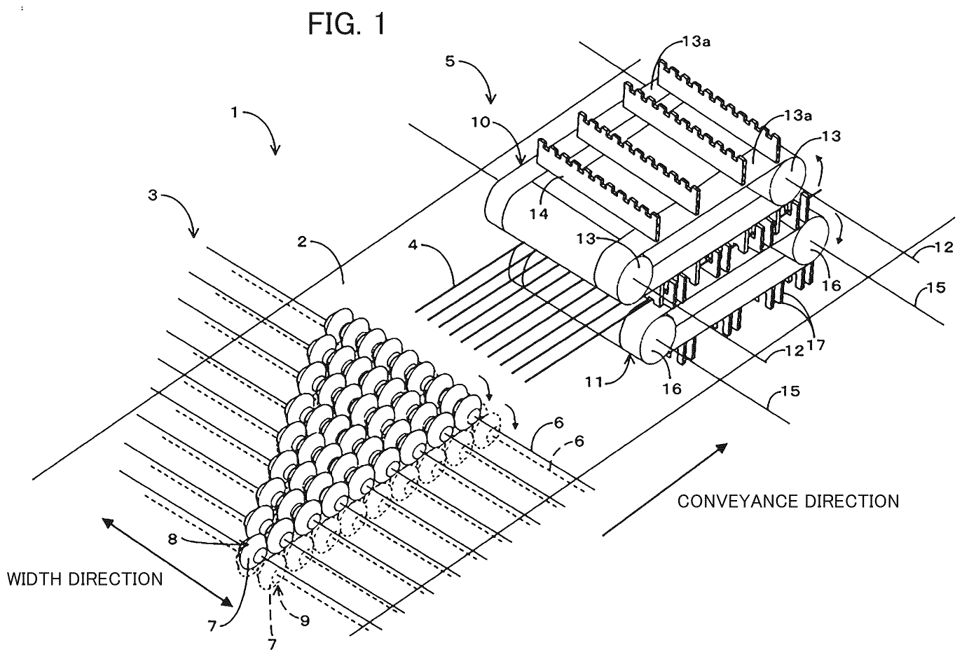

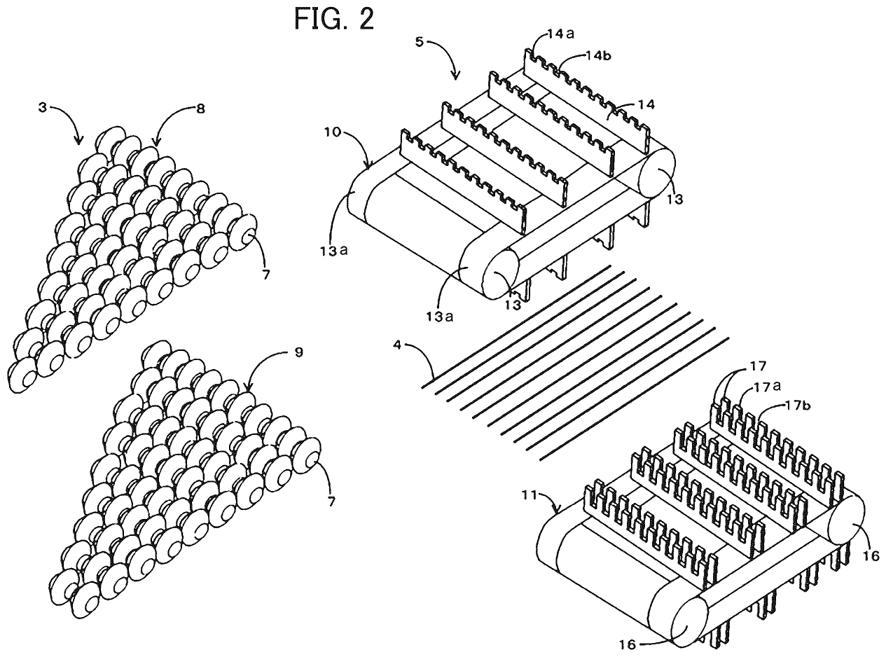

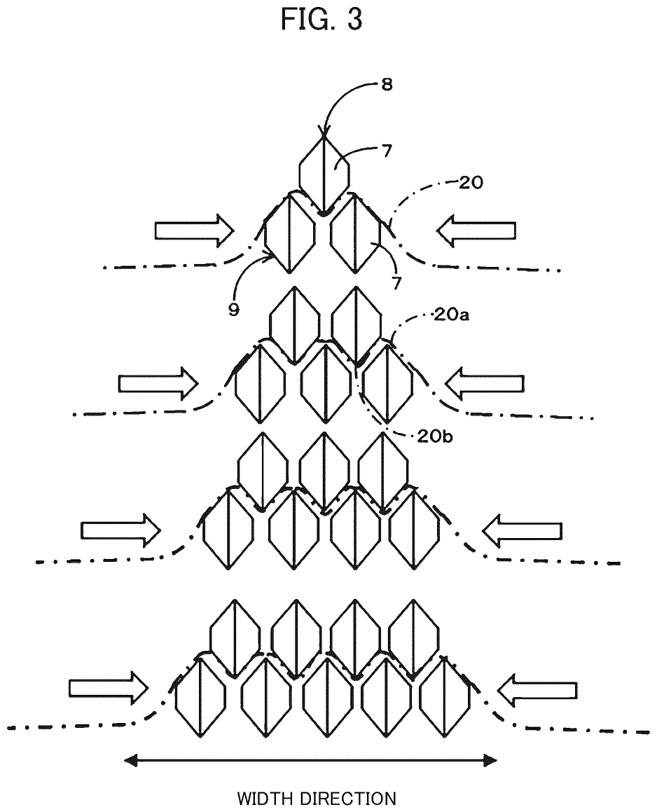

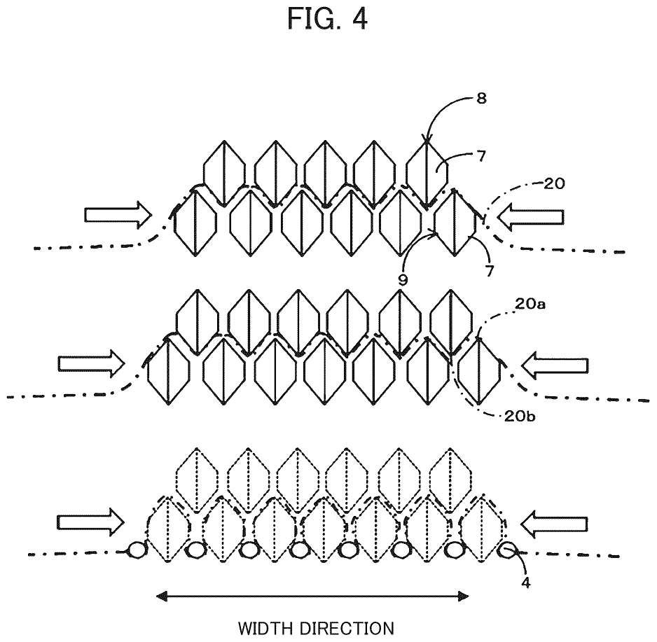

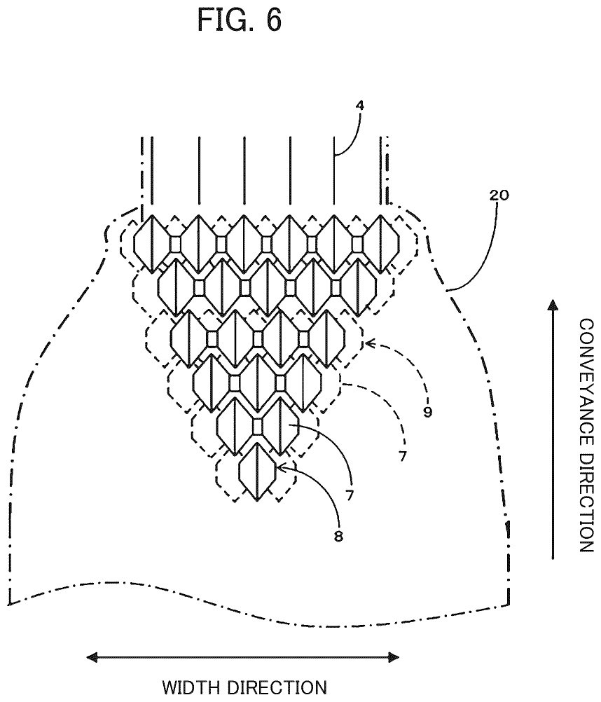

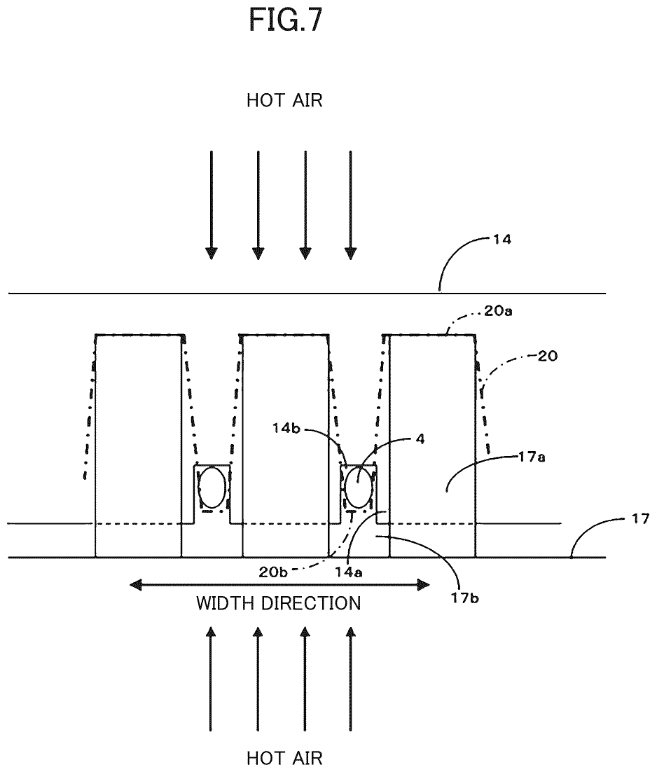

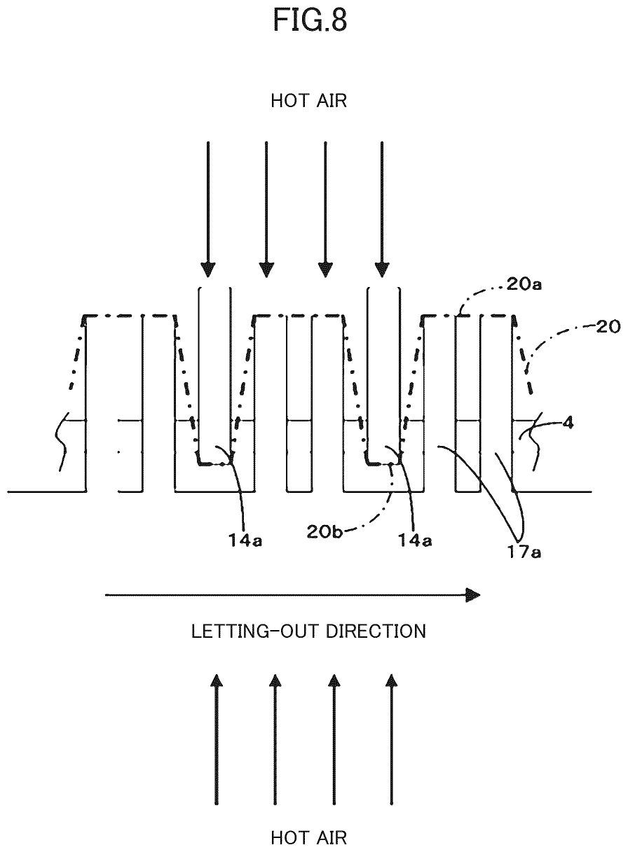

The following describes a preferred embodiment of the present invention with reference to the drawings. FIG. 1 and FIG. 2 are explanatory diagrams schematically illustrating an example of a production apparatus for a shaped fiber sheet according to the present embodiment. FIG. 3 to FIG. 9 are explanatory diagrams schematically illustrating a production method for a shaped fiber sheet.

As illustrated in FIG. 1 and FIG. 2, a production apparatus 1 for a shaped fiber sheet includes a conveyance path 2 for conveying a long fiber sheet, a bend forming unit 3 that bends the fiber sheet so that the fiber sheet is creased in the width direction, bend retaining members 4 that retain the bend of the fiber sheet bent and creased in the width direction in the bend forming unit 3, and a shaping unit 5 that bends the fiber sheet into uneven shapes and heats and shapes the fiber sheet bent into the uneven shapes. For example, the bend forming unit 3 bends the fiber sheet into a zigzag shape.

Note that examples of the fiber sheet according to the present embodiment include a paper sheet, a nonwoven fabric sheet, a carbon fiber sheet, a glass fiber sheet, a natural fiber sheet, a functional fiber sheet, a metal sheet, and cloth.

Examples of nonwoven fabric used in the nonwoven fabric sheet include spun-bond nonwoven fabric, spun lace nonwoven fabric, melt-blown nonwoven fabric, thermal-bond nonwoven fabric, air-through nonwoven fabric, air-laid nonwoven fabric, chemical-bond nonwoven fabric, and needle-punch nonwoven fabric.

Examples of the material of the fiber sheet include synthetic fiber such as aramid fiber, glass fiber, cellulose fiber, nylon fiber, vinylon fiber, polyester fiber, polyethylene fiber, polypropylene fiber, polyolefin fiber, acrylic fiber, and rayon fiber, natural fiber such as pulp, kenaf, wool, cotton, bamboo, and hemp, and metal fiber. These may be used in all forms such as single, mixture, composite, and blend.

The bend forming unit 3 includes a plurality of rollers 7 supported by shafts 6 extending in the width direction crossing (for example, orthogonal to) a conveyance direction of the fiber sheet. The plurality of rollers 7 are disposed one above another and are distinguished as an upper stage roller group 8 (solid lines in FIG. 1) disposed on the upper side and a lower stage roller group 9 (dotted lines in FIG. 1) disposed on the lower side. The rollers 7 have a bicone shape obtained by joining bottom surfaces of truncated cones.

In the upper stage roller group 8 and the lower stage roller group 9, the number of supported rollers 7 increases from the upstream side to the downstream side of the conveyance path 2. Specifically, one roller 7 is disposed most upstream in the upper stage roller group 8. Two rollers 7 are disposed most upstream in the lower stage roller group 9. In both of the upper stage roller group 8 and the lower stage roller group 9, the number of rollers 7 increases one by one from the upstream side to the downstream side. The rollers 7 of the upper stage roller group 8 and the rollers 7 of the lower stage roller group 9 are alternately arrayed in the width direction. The rollers 7 of the upper stage roller group 8 penetrate into gaps between the rollers 7 of the lower stage roller group 9.

The shaping unit 5 includes an upper side shaping device 10 that partially pushes down longitudinal crest portions of the fiber sheet bent and creased in the width direction in the bend forming unit 3 and a lower side shaping device 11 that retains the height of the longitudinal crest portions of the fiber sheet bent and creased in the width direction in the bend forming unit 3.

The upper side shaping device 10 includes a pair of rollers 13 supported by shafts 12, which extend in the width direction orthogonal to the conveyance direction of the fiber sheet, and disposed side by side in the conveyance direction and a pair of endless tracks 13a wound at both ends of the rollers 13. Examples of the endless tracks 13a include belts, chains, nets, wires, ropes, threads, and cords. The rollers 13 rotate counterclockwise in a side view in FIG. 1 according to driving of a not-illustrated motor. Note that other members such as gears, sprocket gears, cams, and rims may be used instead of the rollers 13.

A plurality of shaping members 14 are attached to the endless tracks 13a. The shaping members 14 are provided in a row in the conveyance direction to cross the conveyance direction of the fiber sheet 20.

Note that, in the present embodiment, the shaping members 14 are provided in a row to cross the conveyance direction of the fiber sheet at a right angle. However, a relative angle of the crossing may not be limited to the right angle if the shaping members 14 cross the conveyance direction of the fiber sheet.

The shaping members 14 have a rectangular plate shape long in the width direction orthogonal to the conveyance direction of the fiber sheet. Both ends of one long side portions of the shaping members 14 are attached to the endless tracks 13a.

A plurality of protrusions 14a and a plurality of recesses 14b alternately disposed in the width direction orthogonal to the conveyance direction of the fiber sheet are formed at the other long side portions of the shaping members 14. The protrusions 14a and the recesses 14b of the shaping members 14 are disposed side by side to be in the same row in the conveyance direction of the fiber sheet. As will be described below, when the rollers 13 rotate, the endless tracks 13a are driven and the shaping members 14 are driven in the conveyance direction according to the driving of the endless tracks 13a. The protrusions 14a of the shaping members 14 partially push down the longitudinal crest portions of the fiber sheet. As will be described below, the bend retaining members 4 are inserted into the recesses 14b such that the shaping members 14 do not interfere with the bend retaining members 4.

The lower side shaping device 11 includes a pair of rollers 16 supported by shafts 15, which extend in the width direction orthogonal to the conveyance direction of the fiber sheet, and disposed side by side in the conveyance direction and a pair of endless tracks 16a wound at both ends of the pair of rollers 16. Examples of the endless tracks 16a include belts, chains, nets, wires, ropes, threads, and cords. The rollers 16 rotate clockwise in a side view in FIG. 1 according to driving of a not-illustrated motor. Note that other members such as gears, sprocket gears, cams, and rims may be used instead of the rollers 13.

A plurality of shaping members 17 are attached to the endless tracks 16a. The shaping members 17 are disposed side by side in the conveyance direction with two shaping members 17 as a set. The shaping members 17 have a rectangular plate shape long in the width direction. Both ends of one long side portions of the shaping members 17 are attached to the endless tracks 16a.

A plurality of protrusions 17a and a plurality of recesses 17b alternately disposed side by side in the width direction orthogonal to the conveyance direction of the fiber sheet are formed at the other long side portions of the shaping members 17. The protrusions 17a and the recesses 17b of the shaping members 17 are disposed side by side to be in the same row in the conveyance direction of the fiber sheet. When the rollers 16 rotate, the endless tracks 16a are driven and the shaping members 17 are driven in the conveyance direction according to the driving of the endless tracks 16a. The protrusions 17a of the shaping members 17 retain the height of the longitudinal crest portions of the fiber sheet. As will be described below, the bend retaining members 4 are inserted into the recesses 17b such that the shaping members 17 do not interfere with the bend retaining members 4.

The bend retaining members 4 have a bar shape and extend in the conveyance direction. The bend retaining members 4 are disposed side by side at every fixed interval in the width direction orthogonal to the conveyance direction of the fiber sheet. The bend retaining members 4 are installed to be inclined downward from the upstream side to the downstream side. Note that the bend retaining members 4 may not be used according to uneven shapes to be shaped.

An example in which the endless tracks 13a and the endless tracks 16a are used as a pair is described. However, for example, two or more pairs of endless tracks may be used on both sides in the thickness direction of the fiber sheet 20 or the number of endless tracks may be differentiated on one side and the other side.

Next, a method for producing a shaped fiber sheet by the production apparatus 1 for the shaped fiber sheet configured as described above will be described with reference to FIG. 3 to FIG. 6.

As illustrated in FIG. 3 to FIG. 6, in the production method for the shaped fiber sheet in the present embodiment, first, the fiber sheet 20 proceeds to a bending step that includes bending the long fiber sheet 20 while conveying the fiber sheet 20 so that the fiber sheet 20 is creased in a width direction to include longitudinal crest portions 20a and/or longitudinal trough portions 20b extending in the longitudinal direction along the conveyance direction.

For example, in this bending step, it is preferable that, while conveying the long fiber sheet 20, the fiber sheet 20 is creased in the width direction such that the longitudinal crest portions 20a and the longitudinal trough portions 20b extending in the longitudinal direction along the conveyance direction are alternately arranged in the width direction orthogonal to the conveyance direction.

In this step, it is preferable that, in the bend forming unit 3, the fiber sheet 20 passes through gaps between the rollers 7 of the upper stage roller group 8 and the rollers 7 of the lower stage roller group 9. Upon passage of the fiber sheet 20 passes through the gaps between the rollers 7 of the upper stage roller group 8 and the rollers 7 of the lower stage roller group 9, the fiber sheet 20 is brought into a state conforming to the shape of the rollers 7. As a result, the fiber sheet 20 is pulled closer to the width direction center. Since the plurality of rollers 7 are arrayed in the conveyance direction and the width direction, the fiber sheet 20 can be bend to be creased in the width direction such that the longitudinal crest portions 20a and the longitudinal trough portions 20b extending in the longitudinal direction in the conveyance direction are alternately arranged in the width direction.

Note that, in this step, an example in which the fiber sheet 20 is bent and creased in the width direction to include the longitudinal crest portions 20a and the longitudinal trough portions 20b is described. However, the fiber sheet 20 may be bend to be creased in the width direction to include one of the longitudinal crest portions 20a and the longitudinal trough portions 20b.

Subsequently, it is preferable that the fiber sheet 20 proceeds to a retaining step that includes retaining the bend of the fiber sheet 20 bent and creased in the width direction. In this step, the bend retaining members 4 are inserted into the longitudinal trough portions. Accordingly, the longitudinal trough portions 20b become deeper and the bend of the longitudinal trough portions is retained and the bend of the longitudinal crest portions 20a is also retained.

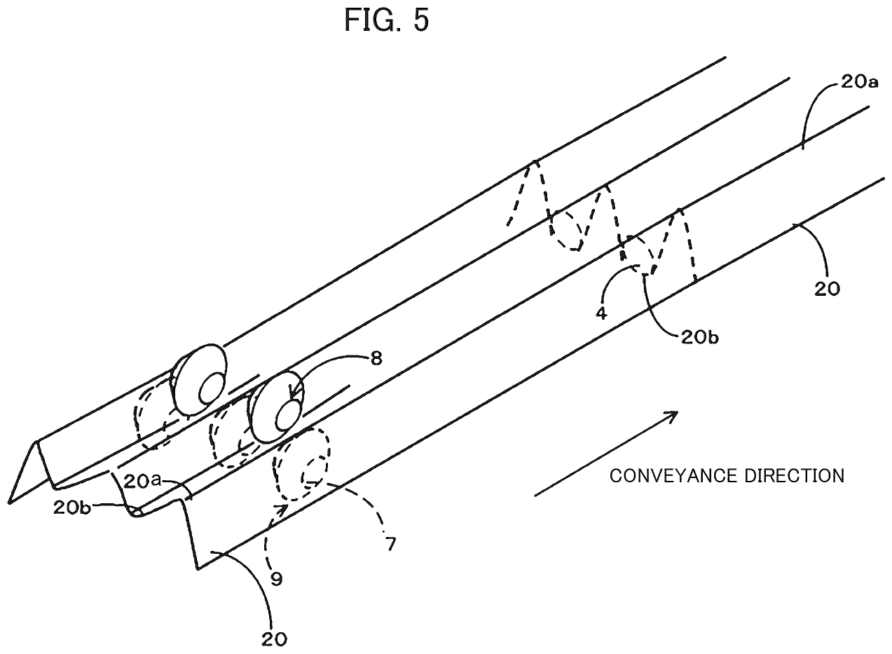

Note that, at this time, although not particularly illustrated, a bend shape in the width direction of the longitudinal crest portions 20a and the longitudinal trough portions 20b may be adjusted from a sine wave shape illustrated in FIG. 5 to a non-sine wave shape such as a rectangular wave shape.

Subsequently, the fiber sheet 20 proceeds to a partially pressing step that includes conveying the fiber sheet 20 bent and creased in the width direction to between the pairs of endless tracks 13a and 16a that are driven in the conveying direction, and partially pressing the longitudinal crest portions 20a and/or the longitudinal trough portions 20b with meshing of the shaping members 14 and 17 provided in a row in the conveying direction in each of the pairs of the endless tracks 13a and 16a.

In this step, the fiber sheet 20 is conveyed to the shaping unit 5. In the shaping unit 5, the rollers 13 rotate counterclockwise in a side view in FIG. 1 according to driving of a motor of the upper side shaping device 10. Accordingly, the endless tracks 13a are driven in the conveyance direction and the shaping members 14 move in the conveyance direction according to the driving of the endless tracks 13a.

On the other hand, in the shaping unit 5, the rollers 16 rotate clockwise in a side view in FIG. 1 according to driving of a motor of the lower side shaping device 11. Accordingly, the endless tracks 16a are driven in the conveyance direction and the shaping members 17 move in the conveyance direction according to the driving of the endless tracks 16a.

The shaping members 14 and the shaping members 17 move in synchronization with the conveyance of the fiber sheet 20. When the shaping members 14 move to positions protruding toward the lower side shaping device 11 in a process of the movement of the shaping members 14 and the shaping members 17 move to positions protruding to the upper side shaping device 10 side in a process of the movement of the shaping members 17, the shaping members 14 and the shaping members 17 move such that the shaping members 14 and the shaping members 17 are alternate in the conveyance direction.

When the fiber sheet 20 enters between the upper side shaping device 10 and the lower side shaping device 11, a pair of protrusions 17a of the shaping member 17 penetrates into the inner side of the longitudinal crest portions 20a of the fiber sheet 20. Accordingly, the height of the longitudinal crest portions 20a is retained.

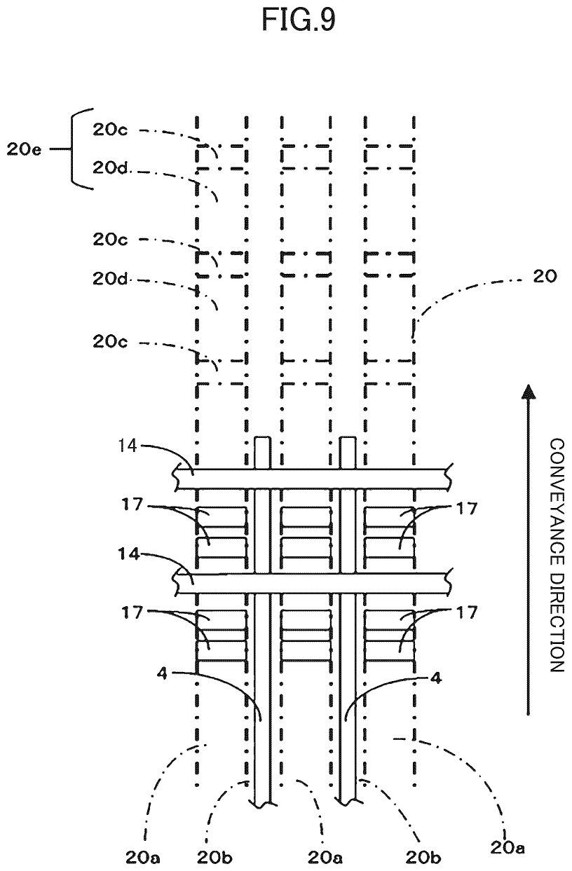

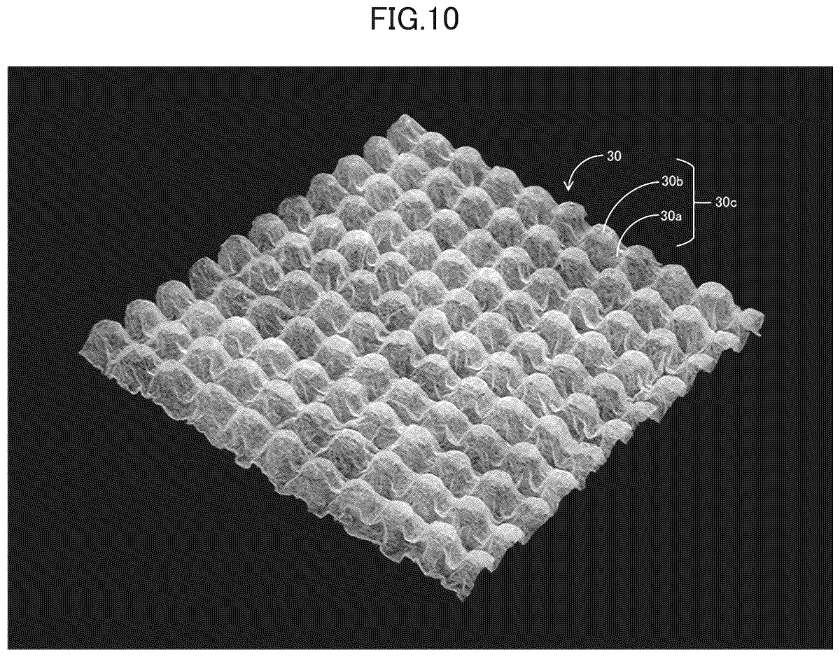

Before or after the height of the longitudinal crest portions 20a is retained by the protrusions 17a of the shaping members 17, the longitudinal crest portions 20a are pressed in a first direction (for example, a downward direction) by the protrusions 14a of the shaping members 14. As described above, with the meshing of the shaping members 14 and 17, the fiber sheet 20 is bent to assume uneven shapes 20e (see FIG. 9) including widthwise trough portions 20c (see FIG. 9) and remaining portions 20d (see FIG. 9) of the longitudinal crest portions 20a.

At this time, since the bend retaining members 4 penetrate into the recesses 17b of the shaping members 17 and the recesses 14b of the shaping members 14, the bend retaining members 4 do not interfere with the shaping members 14 and the shaping members 17.

Subsequently, the fiber sheet 20 proceeds to a heating step that includes heating the fiber sheet 20 that has been bent and assumes the uneven shapes 20e as a result of partially pressing the longitudinal crest portions 20a and/or the longitudinal trough portions 20b.

This step is preferably a heating step that includes heating the fiber sheet 20 that has been bent and assumes the uneven shapes 20e including the widthwise trough portions 20c and the remaining portions 20d of the longitudinal crest portions 20a formed by partially pressing the longitudinal crest portions 20a.

In this step, in the present embodiment, hot air is blown against the fiber sheet 20. Accordingly, the uneven shapes 20e are shaped in the fiber sheet 20. The temperature of the hot air is preferably in a range of 50 degrees to 350 degrees, more preferably 70 degrees to 330 degrees, and more preferably 80 degrees to 300 degrees. Note that the width of the fiber sheet 20 after the fiber sheet 20 passes the bend forming unit 3 until the uneven shapes 20e are shaped is substantially the same.

Note that, means for heating the fiber sheet 20 is not limited to the hot air. Other heading means such as a near infrared ray, a mid-infrared ray, a far infrared ray, conductive heat, steam, ultrasound, superheated steam, a high frequency, a low frequency, an electromagnetic wave, and atmosphere heating may be used.

The step of heating the fiber sheet 20 may be provided in any one of the step of bending the fiber sheet 20 to be creased in the width direction to the step of bending the fiber sheet 20 to assume the uneven shapes 20e in the fiber sheet 20 or may be provided in all of these steps. A direction of the heating may be any direction irrespective of up and down and left and right directions with respect to the fiber sheet 20. Further, the fiber sheet 20 may be set to different temperature for each of the steps or may be gradually heated. While the uneven shapes are shaped or after the uneven shapes are shaped, the fiber sheet 20 may be cooled at temperature lower than the heating temperature.

In the present embodiment, the heights of uneven shapes 30c shaped on a shaped fiber sheet 30 are set uniform. However, the heights may be respectively different heights. Shapes, pitches, and dispositions may not always be uniform and may be different shapes, pitches, and dispositions.

Note that, the present embodiment has been described with reference to the example including the step of partially pressing the longitudinal crest portions 20a in the first direction with the shaping members 14. However, a step of partially pressing the longitudinal trough portions 20b in a second direction with shaping members may be provided. The second direction is, for example, a direction opposite to the first direction and, in the present embodiment, a down-to-up direction. In this case, it is simply required to provide, after this step, a step of heating a fiber sheet that has been bent and assumes uneven shapes including widthwise crest portions and the remaining portions of the longitudinal trough portions 20b formed by partially pressing the longitudinal trough portions 20b.

Note that, as in the present embodiment, by using the endless tracks 13a and 16a, a time (a distance) in which the shaping members 14 and 17 fit in the fiber sheet 20 increases. Therefore, there is an advantage that a heating time can be increased. Accordingly, it is possible to accelerate shaping for the fiber sheet 20. Since the shaping members 14 and 17 can be gradually meshed, the shaping members do not interfere with each other. High projections can be shaped. Further, the height of the projections can be changed during the shaping. For example, compared with the case in which a fiber sheet is shaped using an embossing roll, an apparatus can be reduced in weight. If the embossing roll is used, when it is attempted to form high projections exceeding, for example, 10 mm, since the embossing roll is excessively increased in size, it is difficult to further increase the height of the projections (or increase the depth of recesses).

Note that speed of conveying a fiber sheet bent in width is preferably equal to or higher than driving speed of the endless tracks 13a and 16a. This is because, when an uneven shape is shaped in the fiber sheet, since an excessive tensile force is not applied to the fiber sheet, the fiber sheet is less easily stretched and the fiber sheet is less easily torn. It is possible to bend the fiber sheet in the width direction and bend the fiber sheet with a speed difference between conveyance speed of the fiber sheet in the conveyance direction and driving speed of endless tracks to ensure the distance between crest portions and trough portions.

FIG. 10 is a diagram illustrating a shaped fiber sheet obtained by the production method for the shaped fiber sheet in the present embodiment.

As illustrated in FIG. 10, in the shaped fiber sheet 30 shaped by the production method described above, the uneven shapes (in the figure, uneven shapes 30c including widthwise trough portions 30a and remaining portions 30b of longitudinal crest portions) are repeated and continuous in a surface direction. A crease is formed between the widthwise trough portion 30a and the remaining portion 30b of the longitudinal crest portion. That is, the crease is formed on a side surface portion of the remaining portion 30b. The shaped fiber sheet 30 has elasticity such that, when tension is applied in the surface direction, it stretches to partially or entirely reduce the height of the uneven shapes and, when the tension is eased, it contracts such that the uneven shapes are restored. When the height of the uneven shapes is partially or entirely reduced, for example, the uneven shapes disappear.

Note that, in the present embodiment, the shaped fiber sheet 30 has elasticity regardless of in which direction the tension is applied if the direction is a direction in the surface direction without being limited to the array direction of the uneven shapes 30c. For example, in the case of padding of clothes, bedding, or the like, the padding preferably has a coefficient of extension of restoring even if the padding is extended in a range in which texture is not broken. Specifically, the coefficient of extension is preferably 5% to 300%, more preferably 20% to 300%, and more preferably 20% to 200%.

Here, an example of measurement of the coefficient of extension is described. For example, there is a method of cutting a measurement target shaped fiber sheet in size of 10 cm×10 cm, holding longitudinal and lateral respective facing sides up to a distance of 1 cm to the inner side from the end edge of the sheet and stretching the sheet within a range of not being broken. For example, there is a method of cutting a measurement target shaped fiber sheet in size of 10 cm×10 cm, holding opposite angles at width of 1 cm on the inner side from corners of the sheet, and stretching the sheet in a range of not being broken. Note that these are examples of the measurement of the coefficient of extension. As the measurement method, an appropriate method can be adopted.

The fiber sheet 20 is preferably spun bond, thermal bond, air through, and spun lace. Weight is preferably 5 gsm to 200 gsm, more preferably 5 gsm to 150 gsm, and more preferably 8 gsm to 100 gsm. An area ratio (projection area (projection area after processing)/surface area (original fabric area before processing) ) is preferably 9% to 90%, more preferably 25% to 85%, and more preferably 35% to 80%.

Compared with the creasing indicated by Patent Document 1, the shaped fiber sheet 30 achieves effects that, for example, an external shape, height, elasticity, and the like are easily specified and continuous production are possible. Compared with embossing, since a thin portion (a fragile portion) is less easily formed, the shaped fiber sheet 30 achieves effects that, for example, the shaped fiber sheet 30 is excellent in a restoration property, a function and a feeling of an original fabric are less easily spoiled, and a functional material can be used.

Specifically, in the embossing, since the fiber sheet is compressed and stretched, problems occur in that, for example, a material is crushed, hardened, increased in density in a compressed portion. On the other hand, since the material is stretched in a stretched portion, problems occur in that, for example, the material is weakened (a restoration property is deteriorated) and density decreases. In hollow fiber or the like, a portion destroyed by collapse or stretch occurs and a problem of losing a function of the portion occurs. The same applies to divided fiber and the like. Thus, the embossing is unsuitable for functional fiber. However, in the present embodiment, since the fiber sheet is bent and creased in the width direction beforehand, these problems less easily occur.

In the present embodiment, since the fiber sheet is not (is less easily) compressed and stretched, creases are formed around the projections (mainly in side surface portions). Since the portions where the creases are formed have an effect of reinforcement of support of the projections, a restoration property is satisfactory even if collapse occurs in the projections. Since the embossing is compressed and stretched, if very small holes, cuts, loosening, and the like are present in a fiber sheet (an original fabric) before processing, these are expanded and the fiber sheet becomes defective. On the other hand, in the present embodiment, since the fiber sheet is not (is less easily) compressed and stretched, even if very small holes, cuts, loosening, and the like are present in the fiber sheet (the original fabric) before processing, these are rarely expanded and yield at the time of production is also improved.

Since the shaped fiber sheet 30 in the present invention has the characteristics described above, the shaped fiber sheet 30 is suitable for uses described below.

For example, the shaped fiber sheet 30 is suitable for stuffing (padding). Specifically, the shaped fiber sheet 30 is suitable for stuffing of clothes, bedding, outdoor supplies, a Japanese cushion, and a stuffed toy. Note that, when the shaped fiber sheet 30 is used as the stuffing, for example, cotton balls, down, feathers, tow, beads, straw, foam beads, pellets, grain cotton, SAP, flakes, activated carbon, and zeolite can be used in a space section.

The shaped fiber sheet 30 is suitable for a heat insulating material. For example, the shaped fiber sheet 30 is suitable for a PET bottle cover and a packing material.

The shaped fiber sheet 30 is suitable for a sound absorbing material. For example, the shaped fiber sheet 30 is suitable for a sound proof sheet (an automobile, a house, audio, and the like).

The shaped fiber sheet 30 is suitable for cleaning supplies. For example, the shaped fiber sheet 30 is suitable for a flooring sheet, a cleaning sheet, and wet tissue paper.

The shaped fiber sheet 30 is suitable for an absorbent. For example, the shaped fiber sheet 30 is suitable for a diaper surface material, a sanitary product surface material, a water supply sheet surface material, and a drip sheet.

The shaped fiber sheet 30 is suitable for a dispersion material (a diffusing material). For example, the shaped fiber sheet 30 is suitable for an air freshener, a deodorizer, a disinfectant, an antibacterial agent, an antifungal agent, a humidifier, and a heat dissipating material.

The shaped fiber sheet 30 is suitable for a filter (gas and liquid). For example, the shaped fiber sheet 30 is suitable for a bag, a tube, a laminate, a roll, and a composite.

The shaped fiber sheet 30 is suitable for covers. For example, the shaped fiber sheet 30 is suitable for a stain-proof cover, a dust-proof cover, a rain-proof cover, waterproof cover, an oil-proof cover, a sun protection cover, a sunshade cover, an insect-proof cover, a bird-proof cover, a beast-proof cover, a frost-proof cover

The shaped fiber sheet 30 is suitable for agricultural and forestry materials. For example, the shaped fiber sheet 30 is suitable for a seed bed and a rice straw mat.

The shaped fiber sheet 30 is suitable for construction materials. For example, the shaped fiber sheet 30 is suitable for reinforcement or a core material for a curing sheet, cement, concrete, mortar, putty and an adhesive.

The shaped fiber sheet 30 is suitable for a container. For example, the shaped fiber sheet 30 is suitable for a bag and a fox put in a cell portion.

Note that one shaped fiber sheet 30 may be used or a plurality of shaped fiber sheets 30 may be used one on top of another, may be folded up and used, or may be wound and used. The shaped fiber sheet 30 may be combined with a different fiber sheet or may be stacked in a plurality of layers and used. For example, the shaped fiber sheet 30 may be used by being combined or stacked with cloth, leather, paper, a fiber sheet, a film (a moisture permeable film, an air permeable film, or the like), a sheet, polyolefin fiber orthogonal laminated nonwoven fabric, a net, a mesh, or the like made of a different material. Examples of the material include cotton, hemp, bamboo, kenaf, natural leather, synthetic leather, silk, wool, pulp, rayon, viscose, polyester, polyethylene, polypropylene, styrene, ABS, acrylic, nylon, polycarbonate, polyvinyl chloride, urethane, synthetic resin, and the like, aluminum, silver, gold, platinum, copper, iron, Stainless steel, metals, and the like, natural rubber, synthetic rubber, elastomer, and silicon. The material may be either a natural, synthetic, or semi-synthetic material. These materials may be single, mixed, composite, and blended materials. The shaped fiber sheets 30 may be joined and used, for example, the shaped fiber sheets 30 are joined to each other, the shaped fiber sheet 30 is joined to a different fiber sheet, or the shaped fiber sheet 30 is joined to a film or the like. In this case, examples of a joining method include bonding, thermal welding, ultrasonic welding, high-frequency welding, low-frequency welding, crimping, and sewing. However, the joining method is not limited to these methods.

Note that, when the shaped fiber sheet is used as padding of clothes, bedding, a sleeping bag, or the like, the width of the projections of the shaped fiber sheet is preferably larger than the width of the recesses of the shaped fiber sheet. Accordingly, the height can be retained because, when the shaped fiber sheets are laid one top of another to face one another, the shaped fiber sheets are not fit with one another.

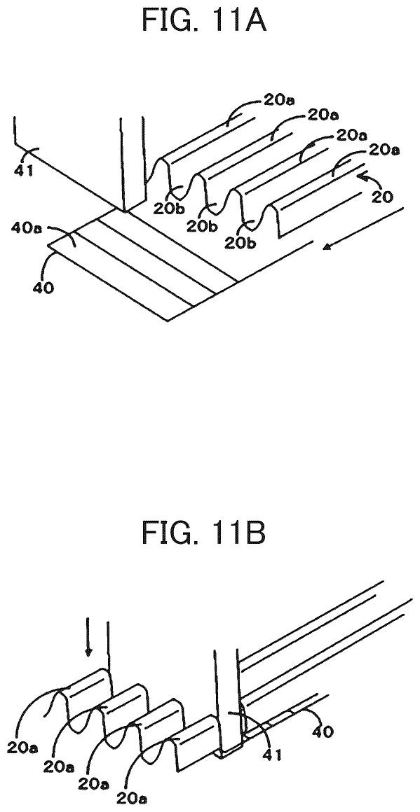

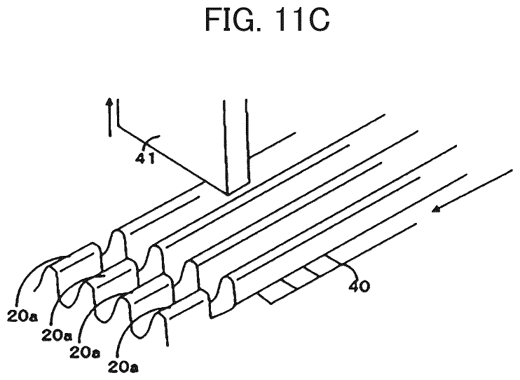

In the embodiment, while the height being retained by the shaping members 17, the longitudinal crest portions 20a of the fiber sheet 20 are partially pressed in the width direction by the shaping members 14. However, the longitudinal crest portions 20a may be partially pressed in the width direction by another method. FIG. 11 is an explanatory diagram illustrating a modification of the production method for the shaped fiber sheet.

For example, as illustrated in FIG. 11A, the fiber sheet 20 bent so that the fiber sheet 20 is creased in the width direction in the same manner as the production method described above is caused to pass above a plate 40 including a long hole 40a extending in the width direction.

Then, as illustrated in FIG. 11B, when the fiber sheet 20 passes above the long hole 40a, a protrusion-shaped shaping member 41 is inserted into the long hole 40a.
Accordingly, as illustrated in FIG. 11C, the longitudinal crest portions 20a of the fiber sheet 20 can be partially pressed in the width direction.

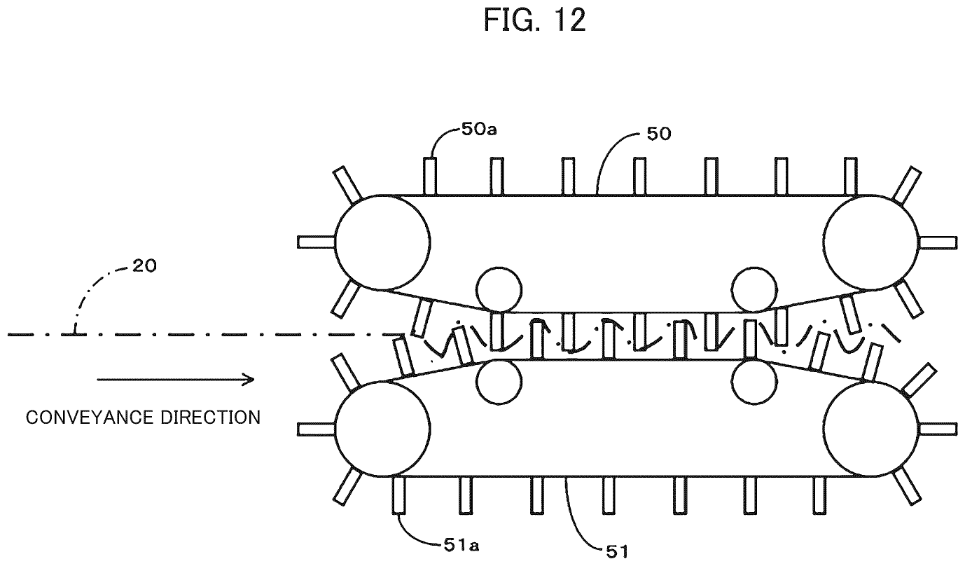

The above embodiment has been described with reference to the example in which the endless tracks 13a and 16a are formed in the linear shape. However, as illustrated in FIG. 12, when the fiber sheet 20 is conveyed to between an endless track 50 on the upper side and an endless track 51 on the lower side, the endless tracks 50 and 51 may be gently inclined in an entrance portion 52 and an exit portion 53 to which the fiber sheet 20 is conveyed.

Accordingly, shaping members 50a provided in the endless track 50 and shaping members 51a provided in the endless track 51 can be gradually meshed with each other. Therefore, even if the bend retaining member 4 is not provided, it is possible to shape the uneven shape on the fiber sheet 20 while deepening the bend of the fiber sheet 20. It is possible to smoothly convey the fiber sheet 20.

The above embodiment has been described with reference to the example in which the fiber sheet 20 passes through the gaps between the rollers 7 of the upper stage roller group 8 and the rollers 7 of the lower stage roller group 9, whereby the fiber sheet 20 is bent and creased in the width direction. However, a method of bending the fiber sheet 20 to be creased in the width direction may not be limited to the method described in the embodiment.

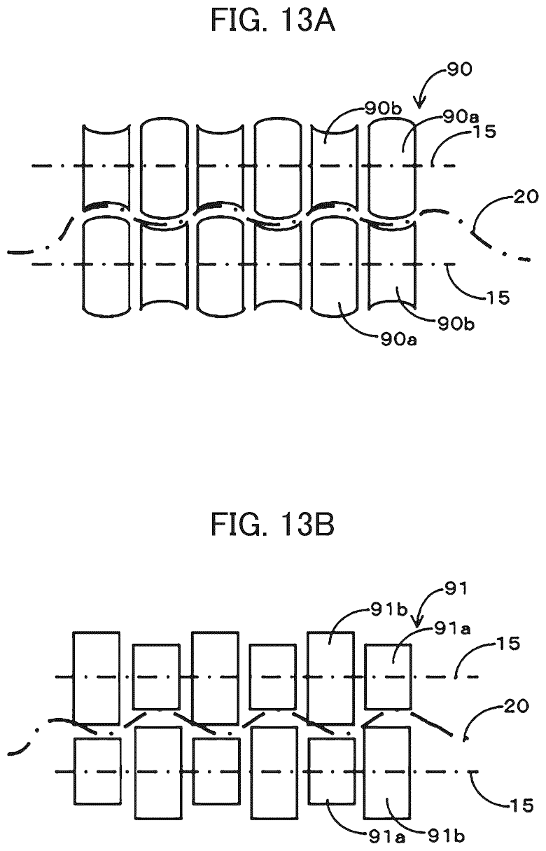

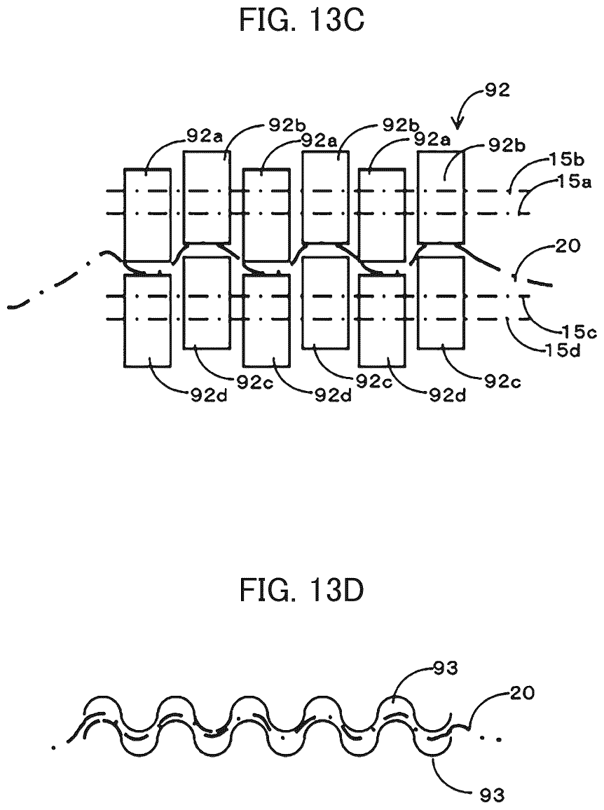

For example, as illustrated in FIG. 13A, the fiber sheet 20 can be bent by clamping the fiber sheet 20 with wavy rollers 90 disposed one above the other. Specifically, as the rollers 90, rollers 90a, the distal ends of which have a shape convex toward the fiber sheet 20, and rollers 90b, the distal ends of which have a concave shape toward the fiber sheet 20 are provided. The rollers 90a and the rollers 90b are alternately disposed in the width direction and are disposed to face each other via the fiber sheet 20. The rollers 90a and 90b are supported by each of a pair of shafts 15 extending in the width direction and disposed one above the other and the fiber sheets 20 is clamped by the rollers 90a and 90b from above and below the fiber sheet 20.

For example, as illustrated in FIG. 13B, the fiber sheet 20 can be bent by clamping the fiber sheet 20 with rollers 91 disposed one above another and having different diameters. Specifically, as the rollers 91, rollers 91a having a short diameter and rollers 91b having a long diameter are provided. The rollers 91a and the rollers 91b are alternately disposed in the width direction and disposed to face each other via the fiber sheet 20. The rollers 91a and 91b are supported by each of the pair of shafts 15 extending in the width direction and disposed one above the other and the fiber sheet 20 is clamped by the rollers 91a and 91b from above and below the fiber sheet 20.

For example, as illustrated in FIG. 13C, the fiber sheet 20 can be bent by clamping the fiber sheet 20 with uneven rollers 92. Specifically, a pair of shafts 15a and 15b different in height in the up-down direction is provided on the upper side of the fiber sheet 20. The shaft 15b is disposed further on the upper side than the shaft 15a. A pair of shafts 15c and 15d different in height in the up-down direction is also provided on the lower side of the fiber sheet 20. The shaft 15c is diapsid further on the upper side than the shaft 15d. As the rollers 92, rollers 92a, 92b, 92c, and 92d having the same shape and the same size are provided.

The rollers 92a are supported by the shaft 15a and the rollers 92b are supported by the shaft 15b, whereby the rollers 92a and 92b are made uneven in the up-down direction. The rollers 92c are supported by the shaft 15c and the rollers 92d are supported by the shaft 15d, whereby the rollers 92c and 92d are made uneven in the up-down direction. The rollers are disposed such that the rollers 92a and the rollers 92b face via the fiber sheet 20 and the rollers 92b and the rollers 92c face via the fiber sheet 20, whereby the rollers supported by the shafts separated from the fiber sheet 20 are prevented from facing each other to reduce gaps between the rollers. The fiber sheet 20 is clamped by the rollers 92a and 92b and the rollers 92c and 92d from above and below the fiber sheet 20.

For example, as illustrated in FIG. 13D, the fiber sheet 20 can be bent by clamping the fiber sheet 20 with wavy wire rods 93 disposed one above the other. Specifically, a plurality of wire rods 93 are disposed side by side in the conveyance direction and the fiber sheet 20 is clamped by the wire rods 93 from above and below the fiber sheet 20.

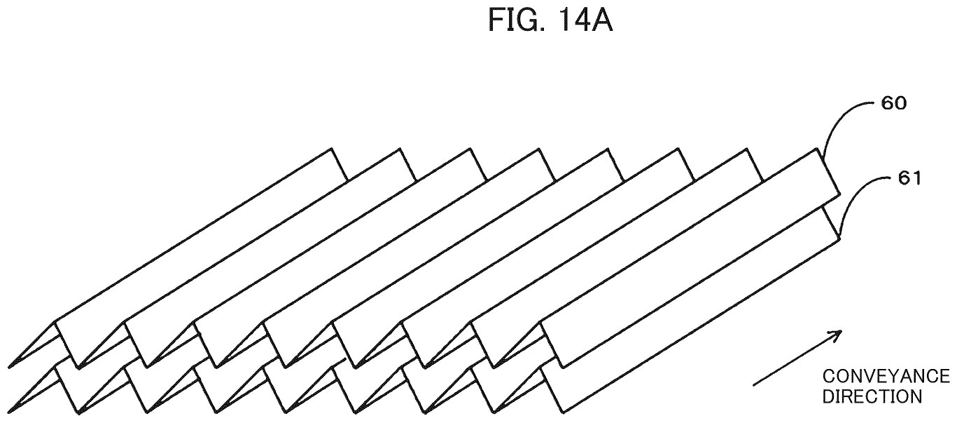

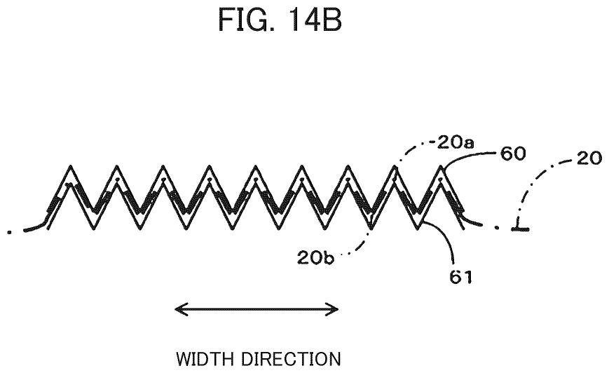

For example, as illustrated in FIG. 14A, folded plates 60 and 61 disposed one above the other are disposed upstream of the shaping unit 5. As illustrated in FIG. 14B, the fiber sheet 20 is conveyed to pass through a gap between the folded plates 60 and 61 disposed one above the other, whereby the longitudinal trough portions 20b may be formed by the folded plate 60 on the upper side and the longitudinal crest portions 20a may be formed by the folded plate 61 on the lower side to bend the fiber sheet 20 to be creased in the width direction.

Besides, a method of bending the fiber sheet 20 is not limited to the embodiment described above if the fiber sheet 20 can be bent by, for example, pressing a protrusion against the fiber sheet 20, bending the fiber sheet 20 with a wavy suction box, bending the fiber sheet 20 with partial vacuum, or bending the fiber sheet 20 with strong and weak vacuum.

The above embodiment had been described with reference to the example in which, in the step of partially pressing the longitudinal crest portions 20a and the longitudinal trough portions 20b of the fiber sheet 20 bent and creased in the width direction, the height of the fiber sheet 20 is not changed. However, the height of the fiber sheet 20 may be adjusted.

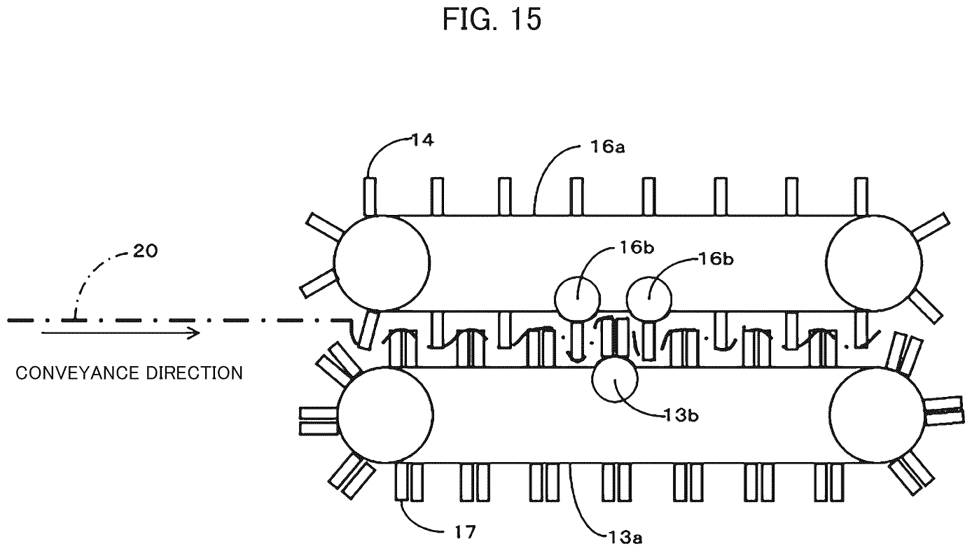

For example, as illustrated in FIG. 15, by disposing rollers 13b and 16b that change tracks of the endless tracks 13a and 16a, it is possible to adjust the height of the fiber sheet 20 to increase. Note that the height of the fiber sheet 20 may be adjusted to decrease.

By providing a low portion and a high portion of the uneven shapes of the shaped fiber sheet as described above, when the shaped fiber sheet is folded or the shaped fiber sheets are laid one on top of the other to use the shaped fiber sheets such that the front surfaces and the rear surfaces face and overlap, it is possible to reduce interference of the projections. For example, when the shaped fiber sheet is used as padding of clothes, it is possible to prevent the projections from being conspicuous from the surface.

The above embodiment has been described with reference to the example in which the uneven shapes of the shaped fiber sheet are disposed in the same row in the conveyance direction. However, the positions in the width direction of the uneven shapes of the shaped fiber sheet may be shifted to be alternate.

For example, the positions of the protrusions 14a in the width direction are shifted by shifting the relative positions in the width direction of the shaping members 14 and the positions of the protrusions 17a in the width direction are shifted by shifting the relative positions in the width direction of the shaping members 17 in the sets. By disposing the shaping members 14 and the shaping members 17 to be meshed as described above, it is possible to shift the positions of the uneven shapes of the shaped fiber sheet in the width direction.

In the embodiment described above, the fiber sheet 20 is bent to assume the uneven shapes by the protrusions 14a of the shaping members 14 and the protrusions 17a of the shaping members 17. However, the shape of the shaping members may be a shape different from the shape in the embodiment.

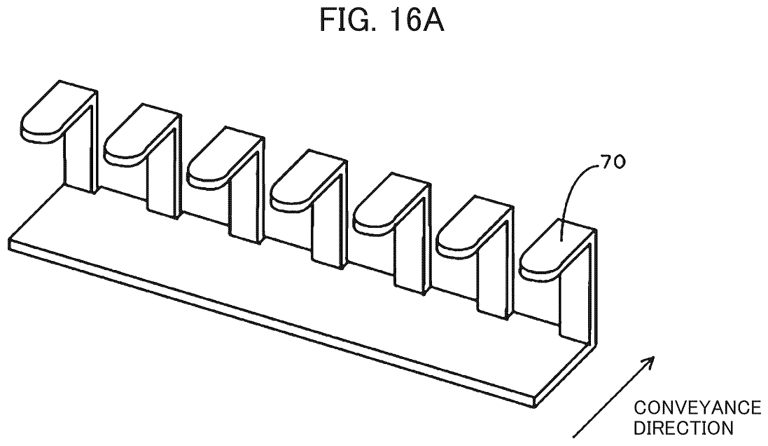

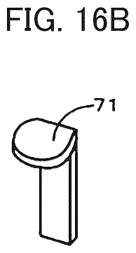

For example, as illustrated in FIG. 16A, the fiber sheet 20 may be bent to assume the uneven shapes by shaping members 70, the distal end portions of which are folded in a direction opposite to the conveyance direction of the fiber sheet 20. Note that the distal end portions of the shaping members 70 are formed in an arc shape in order to prevent the fiber sheet 20 from being caught by the distal end portion. However, as a modification of the shaping members 70, like a shaping member 71 illustrated in FIG. 16B, not only the distal end portion but also a folded tip may be formed in a substantially circular shape.

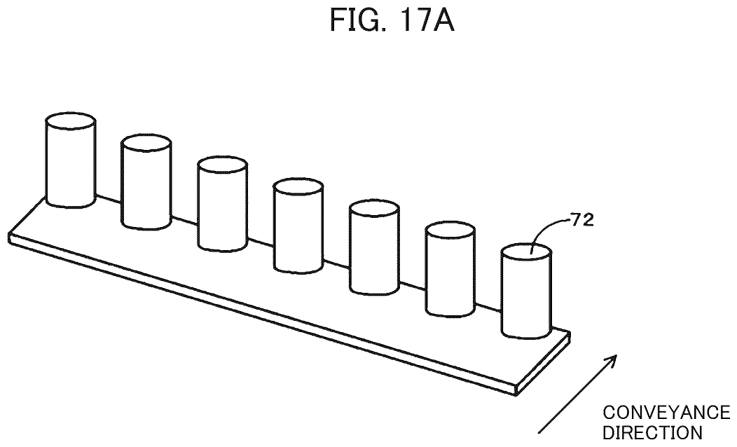

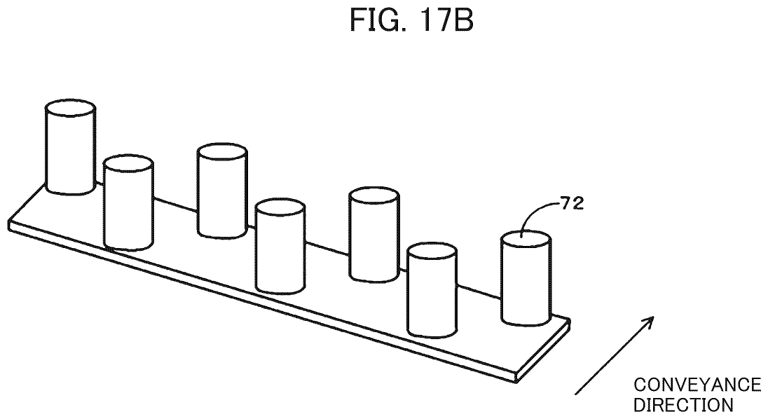

For example, as illustrated in FIG. 17A, the fiber sheet 20 may be bent to assume the uneven shapes by columnar shaping members 72. In an example illustrated in FIG. 17A, the shaping members 72 are linearly arrayed in the width direction orthogonal to the conveyance direction of the fiber sheet 20. However, as illustrated in FIG. 17B, the shaping members 72 may be arrayed in the width direction such that the positions in the conveyance direction are alternate. Further, although not illustrated, deformed shaping members may be arrayed.

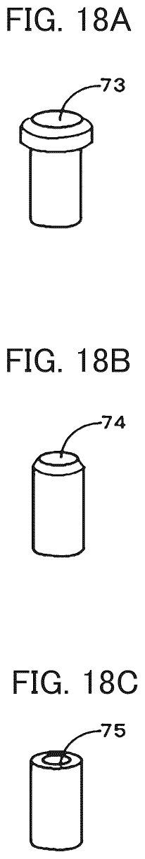

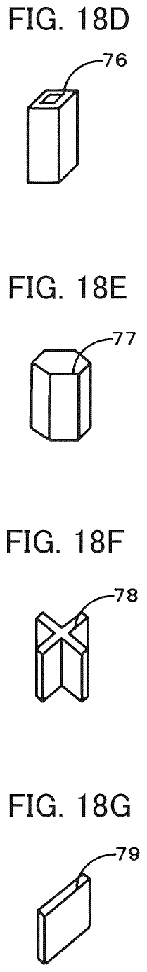

Note that, as a modification of the shaping members 72, as illustrated in FIG. 18A, a shaping member 73, the distal end portion of which is a pan head shape, may be used. As illustrated in FIG. 18B, a shaping member 74, the distal end portion of which is chamfered, may be used. As illustrated in FIG. 18C, a circular tubular shaping member 75 may be used. As illustrated in FIG. 18D, a square tubular shaping member 76 may be used. In examples illustrated in FIG. 18C and FIG. 18D, since a portion not pressed is present on the top surface, the portion can further prevent a feeling and a function of an original fabric from being spoiled. As illustrated in FIG. 18E, a polygonal columnar shaping member 77 may be used. As illustrated in FIG. 18F, a cross columnar shaping member 78 may be used. As illustrated in FIG. 18G, a shaping member 78 having a protrusion shape long in the conveyance direction may be used. Besides, for example, a shaping member having an antiprism shape like a star shape may be used. The shape of the shaping member is not limited to the shapes exemplified in the present embodiment.

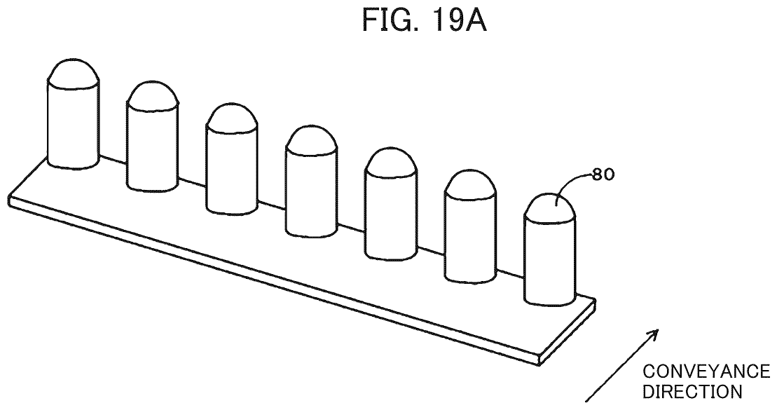

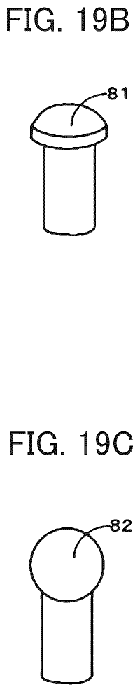

For example, as illustrated in FIG. 19A, the fiber sheet 20 may be bent to assume the uneven shapes by shaping members 80, the distal ends of which are chamfered to be formed in a curved surface shape. By forming the distal end portions in the curved surface shape as described above, it is possible to smoothly convey the fiber sheet 20. Note that, as a modification of the shaping members 80, as illustrated in FIG. 19B, a shaping member 81, the distal end portion of which is formed in a truss head shape, may be used. As illustrated in FIG. 19C, a shaping member 82, the distal end portion of which is formed in a spherical shape, may be used.

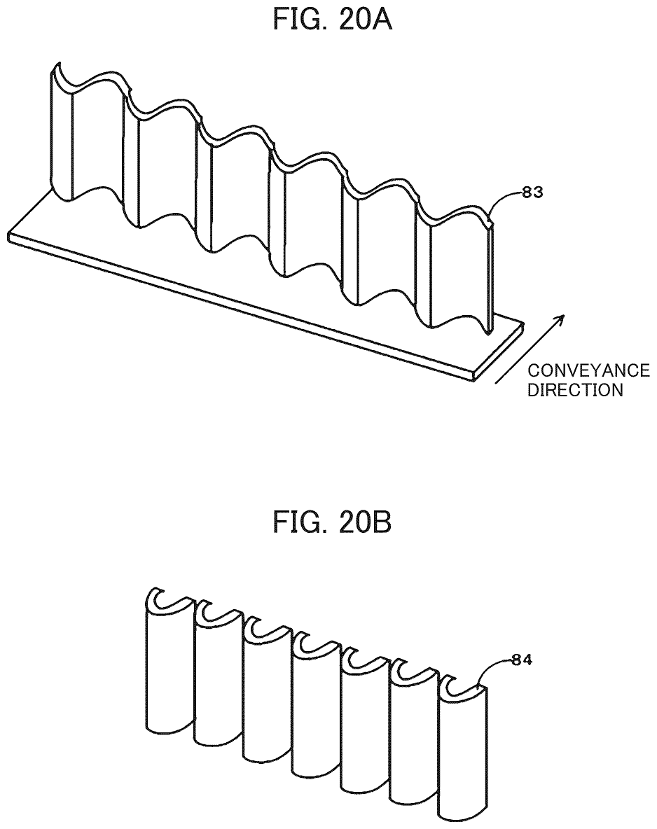

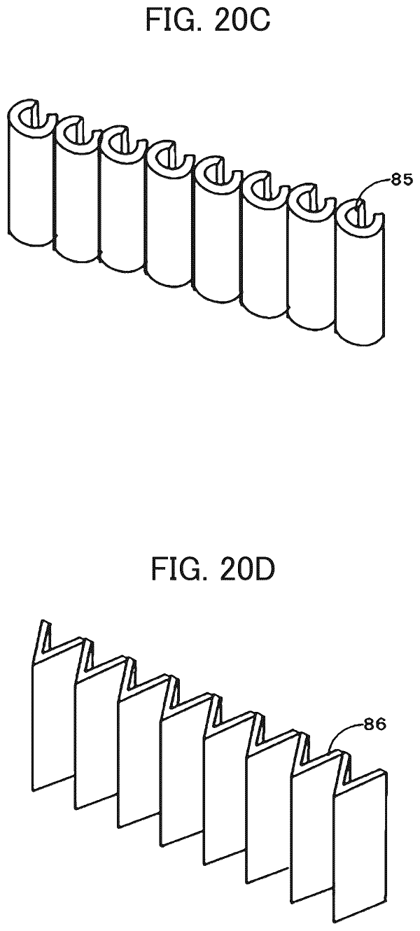

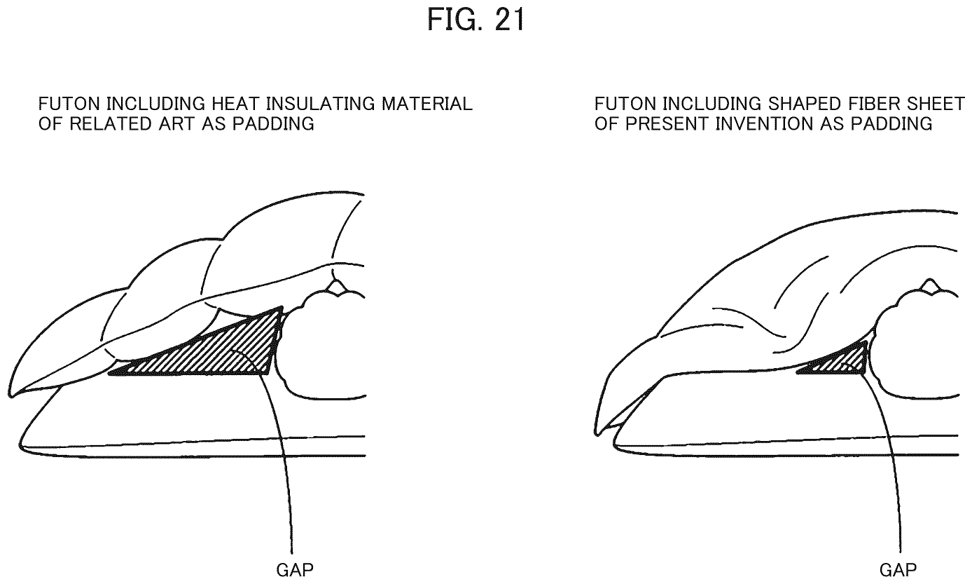

For example, as illustrated in FIG. 20A, the fiber sheet 20 may be bent to assume the uneven shapes by a wavy plate-shaped shaping member 83 including a curved surface-shaped wall surface continuous in the width direction. Note that, as a modification of the shaping member 83, as illustrated in FIG. 20B, a wavy plate-shaped shaping member 84 including a semi-arc-shaped wall surface continuous in the width direction may be used. As illustrated in FIG. 20C, a wavy plate-shaped shaping member 85 including an arc-shaped wall surface bent into a semicircle or larger continuous in the width direction may be used. As illustrated in FIG. 20D, a wavy plate-shaped shaping member 86 including a V-shaped wall surface continuous in the width direction may be used. Besides, an intermittent wavy plate shape, a rectangular wave shape, and the like can be exemplified.

Next, a case in which the shaped fiber sheet 30 produced by the production method of the present invention is used as padding of a fiber product such as clothes or a futon will be specifically described.

In the related art, when down or short-fiber grain cotton is used as padding of products such as a futon or clothes, fiber loss and uneven fiber distribution due to blowout from an outer fabric occur. For this reason, in order to prevent the fiber loss, texture of the outer fabric is limited, for example, a high-density textile is used as the texture of the outer fabric or calendaring needs to be applied to the texture. In order to prevent the uneven fiber distribution, processing such as quilting or stitching is necessary for the outer fabric. However, since the shaped fiber sheet 30 is produced by stacking the fiber sheets 20 having long fiber, fiber loss and uneven fiber distribution due to blowout hardly occur. For this reason, it is possible to prevent occurrence of dust due to the blowout and washing is facilitated.

Since fiber loss due to blowout hardly occurs in the shaped fiber sheet 30, it is possible to increase a degree of freedom of the texture used as the outer fabric. For example, open-weave texture that cannot be used in the related art can be used as the outer fabric. Specifically, low-density texture such as gauze or waffle, knit, stretch textile, or the like can be used as the outer fabric. A fiber orthogonal stacked nonwoven fabric made of polyolefin can be used as a part of a stacked body forming the outer fabric.

Since the shaped fiber sheet 30 hardly has deviation, processing such as quilting or stitching is unnecessary for the outer fabric. For this reason, it is possible to prevent heat from escaping to the outside from a processed portion by quilting, stitching, or the like. Pressing of the padding by the outer fabric decreases and an air layer can be kept larger. As a result, it is possible to further reduce a product in weight than when the padding of the related art is used and it is possible to increase a heat retaining property of a product. It is possible to omit the processed portion by quilting, stitching, or the like for the outer fabric.

An outer fabric having high density and low followability to a body does not need to be used as the outer fabric. Further, since processing such as quilting or stitching is unnecessary for the outer fabric, it is possible to use an outer fabric having low density and high followability to the body. That is, it is possible to use a soft outer fabric having less thickness compared with the related art without using a hard outer fabric having thickness as in the related art. Accordingly, it is possible to increase the followability of the product to the body. For this reason, when the shaped fiber sheet 30 is used as padding of clothes, it is possible to improve wearing comfort. It is also possible to improve designability.

Since the shaped fiber sheet 30 has low density, it is possible to allow stuffiness to escape. Further, it is possible to easily perform moisture absorption and heat generation by stacking rayon nonwoven fabrics.

Here, for example, the shaped fiber sheets 30 can be stacked in ten layers and used as padding of a quilt. As an example, the quilt in which the shaped fiber sheets 30 were used as the padding was approximately 1.9 kg (26 g/m²×10 layers) in a single size (1500 mm in width×2100 mm in length, approximately 50 mm in thickness). In contrast, in the quilt of the same size in which the padding of the related art was used, a down quilt weighed around 2.5 kg, a silk floss quilt weighed around 2.3 kg, a feather quilt weighed around 3 kg, a wool quilt weighed around 3.5 kg, a polyester quilt weighed around 2 kg, and a cotton quilt weighed around 4.5 kg. As described above, the quilt in which the shaped fiber sheets 30 are used as the padding is lighter compared with the quilt in which the padding of the related art is used.

The heat retaining property of the shaped fiber sheet 30 produced by the production method of the present invention was tested by an A method (a constant temperature method) of a test method (JIS L 1096) specified by JIS (Japanese Industrial Standards). Note that the test calculates a heat retention rate (%) from a heat radiation amount (proportional to power consumption) at the time when a constant temperature heating plate is covered with a Japanese cushion of a sample (40 cm×40 cm) and the surface temperature of the constant temperature heating plate is retained at a fixed value (36° C.±0.5° C.: 36 degree Celsius±0.5 degree Celsius). A value in parentheses indicates a CLO value. Note that a result is obtained by measuring one test piece twice.

As a result, the heat retention rate of the shaped fiber sheet 30 (14 g) was 80.1% (3.07), the heat retention rate of grain cotton 3D (14 g) was 73.0% (2.06), the heat retention rate of grain cotton 7D (14 g) was 73.7% (2.13), the heat retention rate of down (14 g) was 84.0% (4.01), the heat retention rate of fine polygon (registered trademark) (14 g) was 78.0% (2.69), and the heat retention rate of the shaped fiber sheet 30 (21 g) was 84.1% (4.02).

As described above, in the shaped fiber sheet 30, the air layer can be formed by taking the air into the spaces formed by the uneven shapes 20e. Therefore, the quilt including the shaped fiber sheet 30 as the padding can obtain an excellent heat retaining property compared with the quilt including the padding of the related art.

As illustrated in FIG. 22, for example, when the shaped fiber sheet 30 of the present invention is used as the padding of the quilt as an example of a fiber product, gaps decrease compared with the padding including the heat insulating material of the related art and the heat retaining property can be improved.

Note that examples of the fiber product include bedding such as futon and a sleeping bag, general clothes, sportswear, clothing materials, interior products such a carpet, a sofa, a curtain, and a cushion, vehicle interior products such as a car seat, life applications such as cosmetics, a cosmetic mask, wiping cloth, and a health product, and environmental and industrial material applications such as a filter and a toxic substance removal product.

The present invention has been described based on the preferred embodiment illustrated above. However, the present invention is not limited to only the embodiment described above. It goes without saying that various modifications may be made within the scope of the present invention.

For example, in the step of bending the fiber sheet so that the fiber sheet is creased in the width direction, the fiber sheet may be bent by a method different from the method in the embodiment, for example, a method of bringing the fiber sheet closer to the center in the width direction or bending the fiber sheet in the thickness direction. The shape of the bend is not limited to the shape in the present embodiment and may be a shape different from the shape in the embodiment.

In the step of bending the fiber sheet so that the fiber sheet is creased in the width direction, the bending may not be limited to the form of bending the fiber sheet in the zigzag shape. For example, the fiber sheet may be bent in a form different from the form in the embodiment, for example, a form of bending the fiber sheet such that one stripe of longitudinal crest portions and longitudinal trough portions extending in the conveyance direction is formed in the fiber sheet.

The embodiment has been described with reference to the example in which, in the step of heating the fiber sheet 20 that has been bent and assumes the uneven shapes 20e by partially pressing the longitudinal crest portions 20a and/or the longitudinal trough portions 20b, the fiber sheet 20 is shaped by blowing the hot air against the fiber sheet 20 from both the sides. However, in the step of heating the fiber sheet 20, the hot air may be blown against the fiber sheet 20 from one side of the fiber sheet 20, the hot air blown against the fiber sheet 20 may be suctioned on the other side of the fiber sheet 20, and the suctioned hot air may be blown against the fiber sheet 20 from one side again. By blowing the suctioned hot air against the fiber sheet 20 again as described above, it is possible to reduce heat loss. Since the fiber sheet 20 is pressed against the shaping members 14 and 17 by the suction, it is easy to shape the uneven shapes 20e on the fiber sheet 20.

### EXPLANATION OF REFERENCE NUMERALS

1: Production apparatus for shaped fiber sheet
2: Conveyance path
3: Bend forming unit
4: Bend retaining member
5: Shaping unit
10: Upper side shaping device
11: Lower side shaping device
20: Fiber sheet
20a: Longitudinal crest portion
20b: Longitudinal trough portion
30: Shaped fiber sheet

1. A method for producing a shaped fiber sheet, the method comprising:
a bending step including bending a long fiber sheet while conveying the fiber sheet so that the fiber sheet is creased in a width direction to include a longitudinal crest portion and/or a longitudinal trough portion extending in a longitudinal direction along a conveyance direction;
a partially pressing step including conveying the fiber sheet bent and creased in the width direction to between endless tracks that are provided on both sides of the fiber sheet in a thickness direction and driven in the conveyance direction and that have shaping members disposed in a row in the conveyance direction, and partially pressing the longitudinal crest portion and/or the longitudinal trough portion with meshing of the shaping members; and
a heating step including heating the fiber sheet that has bent and assumes an uneven shape as a result of partially pressing the longitudinal crest portion and/or the longitudinal trough portion.

2. The method according to claim 1, wherein, in the partially pressing step, height of the longitudinal crest portion and/or the longitudinal trough portion can be adjusted.

3. The method according to claim 1, wherein, in the bending step, while conveying the fiber sheet, the fiber sheet is creased in the width direction such that the longitudinal crest portion and the longitudinal trough portion are alternately arranged in the width direction orthogonal to the conveyance direction.

4. The method according to claim 3, wherein, in the bending step, by conveying the fiber sheet to pass through a gap between rollers disposed one above another, the longitudinal trough portion is formed by the roller on an upper side and the longitudinal crest portion is formed by the roller on a lower side so that the fiber sheet is bent and creased in the width direction.

5. The method according to claim 3, wherein, in the partially pressing step, by conveying the fiber sheet to pass through a gap between folded plates disposed one above another, the longitudinal trough portion is formed by the folded plate on an upper side and the longitudinal crest portion is formed by the folded plate on a lower side so that the fiber sheet is bent and creased in the width direction.

6. The method according to claim 1, further comprising a retaining step including retaining the bend of the fiber sheet bent and creased in the width direction.

7. The method according to claim 1, wherein, in the heating step, the fiber sheet is heated by blowing hot air against the fiber sheet from one side of the fiber sheet, the hot air blown against the fiber sheet is suctioned on another side of the fiber sheet, and the suctioned hot air is blown against the fiber sheet from the one side again.

8. A shaped fiber sheet comprising a region where a plurality of uneven shapes having regularity are formed, wherein
a coefficient of extension in the region is 20% or higher, and a ratio of a projection area of the shaped fiber sheet to a surface area of the fiber sheet before the uneven shapes are formed is 80% or lower.

9. The shaped fiber sheet according to claim 8, wherein the uneven shapes are repeated and continuous in a surface direction and the shaped fiber sheet has such an elasticity that, when tension is applied in the surface direction, the shaped fiber sheet stretches to partially or entirely reduce height of the uneven shapes and, when the tension is eased, the shaped fiber sheet contracts to restore the uneven shapes.

10. The shaped fiber sheet according to claim 8, wherein the shaped fiber sheet is stacked in a plurality of layers such that a material of at least one layer is different.

11. The shaped fiber sheet according to claim 8, wherein the shaped fiber sheet is stacked in a plurality of layers and used as padding.

12. A fiber product, comprising the shaped fiber sheet produced by the method according to claim 1, the shaped fiber sheet being used as padding.
